(19) United States
(12) Patent Application Publication
(10) Pub. No.: US 2004/0002345 A1
(43) Pub. Date: Jan. 1, 2004

(54) Network connection management system and network connection management method used therefor

(75) Inventor: Yuzo Miki, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/462,672

(22) Filed: Jun. 17, 2003

(30) Foreign Application Priority Data
Jun. 26, 2002 (JP) 185420/2002

(51) Int. Cl. H04M 1/66; H04M 1/68; H04M 3/16

(52) U.S. Cl. 455/456.1; 455/411

(57) ABSTRACT

There is provided a network connection management system which is capable of performing control of connection or access to a network easily without requiring a dedicated device. A user wishing to access an information server apparatus uses a portable communication terminal to send ID information and location information. ID information of the user, location information of major accessible places, and access levels based upon the ID information, the location information, and time information are stored in the information server apparatus in advance. The information server apparatus sends connection permission information, which is based upon the ID information and the location information of the user, to the terminal. Upon receiving the connection permission information in the terminal, the user makes connection to the information server apparatus from an information processing apparatus via a communication network based upon the connection permission information and carries out jobs or the like.

### BACKGROUND OF THE INVENTION

1. Field of the Invention

The present invention relates to a network connection management system and a network connection management method used therefor, and in particular to a method of preventing illegal connection to a network.

2. Description of the Related Art

In recent years, as means for preventing illegal connection to a network, a fingerprint reader, an ID card reader, or the like are used. That is, authentication of an identification of a user is performed by lifting a fingerprint of the user with the fingerprint reader or by causing the user to insert an ID card distributed to each user into the ID card reader to read contents of the ID card with the ID card reader.

In. addition, following the development of a network (information communication network), places where users carry out jobs or the like have expanded from offices to other places such as homes of the users and satellite offices.

However, in the conventional method of preventing illegal connection to a network, a dedicated device such as the fingerprint reader or the ID card reader is required as the means for preventing illegal connection to a network, and control of connection or access to a network cannot be performed easily.

### BRIEF SUMMARY OF THE INVENTION

It is an object of the present invention to solve the above-described problem and provide a network connection management system, which can easily perform control of connection or access to a network without requiring a dedicated device, and a network connection management method used therefor.

A network connection management system according to the present invention includes: a portable communication terminal including a location information detecting unit which detects location information of the terminal; an access management server which, upon judging that connection to a network is to be permitted based upon a communication network connection request including at least ID information and location information from the portable communication terminal, sends to the portable communication terminal connection permission information for permitting connection to the network; and an information processing apparatus for making connection to the network by sending the connection permission information obtained by the portable communication terminal.

A network connection management method according to the present invention includes, upon judging that connection to a network is to be permitted based upon a communication network connection request including at least ID information and location information from a portable communication terminal including a location information detecting unit which detects location information of the terminal, sending connection permission information, which permits connection to the network, to the portable communication terminal from an access management server for managing the connection permission information; and making connection to the network by sending the connection permission information, which is obtained by the portable communication terminal, from an information processing apparatus.

That is, the network connection management system according to the present invention makes it possible to perform control of access to a network easier by utilizing the portable information terminal provided with the location information detecting unit.

In addition, the network connection management system according to the present invention makes it possible to perform attendance management of a user appropriately by managing start time and end time of access to the network based upon the location information.

Consequently, the network connection management system according to the present invention makes it possible to perform management of access to the network easily by utilizing the portable information terminal provided with the location information detecting unit without depending upon a dedicated device such as a fingerprint reader or an ID card reader.

In addition, in the network connection management system according to the present invention, even in the case in which start time and end time of access to the network are managed to perform arrival and departure management (attendance management) of a user, since access is also confirmed according to location information of the portable information terminal, for example, it becomes possible to eliminate access from places other than those designated in advance (access other than that for business) and to perform appropriate management.

### BRIEF DESCRIPTION OF THE DRAWINGS

In the accompanying drawings:

FIG. 1 is a block diagram showing a configuration of a network connection management system according to an embodiment of the present invention;

FIG. 2 is a block diagram showing a configuration of a portable communication terminal of FIG. 1;

FIG. 3 is a block diagram showing a configuration of an information server apparatus of FIG. 1; and

FIG. 4 is a flowchart showing operations of the network connection management system according to the embodiment of the present invention.

### DETAILED DESCRIPTION OF THE PREFERRED EMBODIMENTS

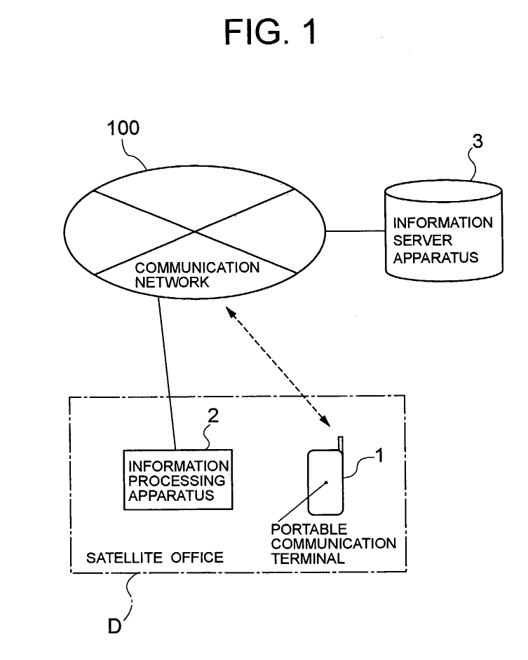

An embodiment of the present invention will be hereinafter described with reference to the accompanying drawings. FIG. 1 is a block diagram showing a configuration of a network connection management system according to the embodiment of the present invention. In FIG. 1, the network connection management system according to the embodiment of the present invention mainly includes: a portable communication terminal 1 provided with a location information detecting unit; an information processing apparatus 2 such as a personal computer; an information server apparatus 3; and a communication network 100 such as the Internet connecting these terminal and apparatuses each other. It is assumed that the portable communication terminal 1 and the information processing apparatus 2 are located in a satellite office D.

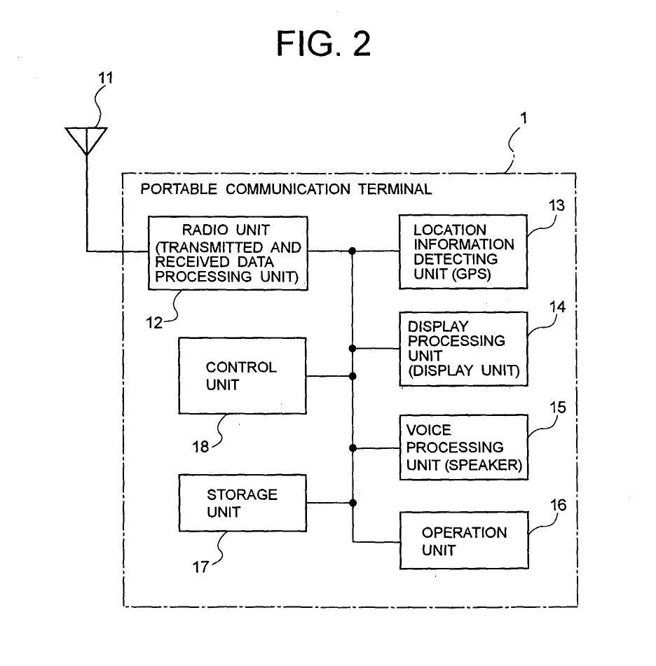

FIG. 2 is a block diagram showing a configuration of the portable communication terminal 1 of FIG. 1. In FIG. 2, the portable communication terminal 1 is a browser phone connectable to the communication network 100 and mainly includes: an antenna 11; a radio unit (transmitted and received data processing unit) 12; a location information detecting unit (GPS: Global Positioning System) 13; a display processing unit (display unit) 14; a voice processing unit (speaker) 15; an operation unit 16; a storage unit 17; and a control unit 18.

The radio. unit 12 includes a transmission and reception circuit and the like and is connected to the communication network 100 to perform transmission and reception of a phone call or data. The location information detecting unit 13 performs detection of location information with the GPS. As means for detecting the location information of the terminal 1, a method other than the GPS may be adopted.

The display processing unit 14 processes image data or character data and causes the display unit to display the processed data. The voice processing unit 15 processes voice and musical sound data. The operation unit 16 performs an input operation of various instructions and information with respect to the portable communication terminal 1. The storage unit 17 stores various data, and the control unit 18 controls the respective parts of the portable communication terminal 1.

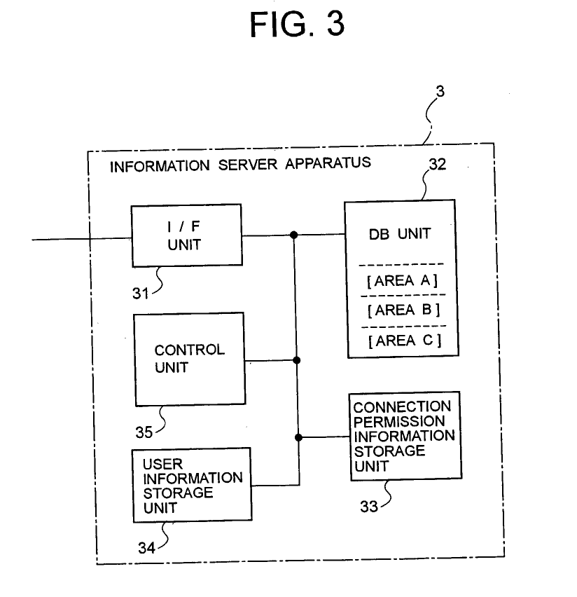

FIG. 3 is a block diagram showing a configuration of the information server apparatus 3 of FIG. 1. In FIG. 3, the information server apparatus 3 is mainly constituted by an information processing apparatus such as a work station server and mainly includes an I/F (interface) unit 31, a DB (database) unit 32, a connection permission information storage unit 33, a user information storage unit 34, and a control unit 35.

The I/F unit 31 is a communication interface which is used when data is sent and received between the information server apparatus 3 and the communication network 100. The DB unit 32 has a plurality of information storage areas (area A, area B, area C, etc.).

The connection permission information storage unit 33 stores ID information of a user, an access level according to location information of the user, connection permission information (password), and the like. The user information storage unit 34 stores ID information and location information of a user as well as connection start time and connection end time of the user. The control unit 35 controls the respective parts of the information server apparatus 3.

It is assumed that the control unit 35 is provided with a function for measuring time, and the connection permission information (password) stored by the connection permission information storage unit 33 is updated periodically or every time the information processing apparatus 2 is connected to the communication network.

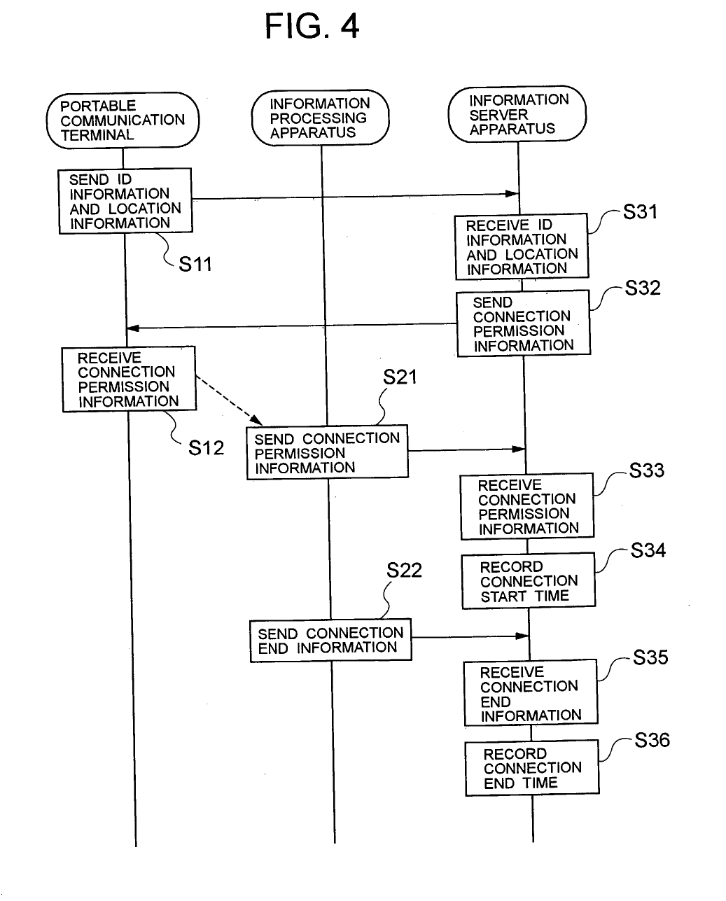

FIG. 4 is a flowchart showing operations of the. network connection management system according to the embodiment of the present invention. The operations of the network connection management system according to the embodiment of the present invention will be described with reference to FIGS. 1 to 4.

Auser, who wishes to access the information server apparatus 3 from a desk of the user in an office, a conference room, a home of the user, a satellite office D, or the like, uses the portable communication terminal 1 to send the ID information and location information of the user (step S11 in FIG. 4).

The connection permission information storage unit 33 of the information server apparatus 3 stores the ID information of each user, the location information of major accessible places (the desk of the user, the conference room, the satellite office D, the home of the user, other places, etc.), and access levels (e.g., access permitted to area A, access permitted to areas A and B, access not permitted, etc.) to the DB unit 32 based upon the ID information, the location information, and the time information in advance.

The information server apparatus 3 judges propriety of connection to the communication network 100 (DB unit 32) based upon the ID information and the location information received from the terminal 1 and contents stored in the connection permission information storage unit 33 and, when it is judged that the connection to the communication network 100 is to be permitted, sends the connection permission information to the portable communication terminal 1 (steps S31 and S32 in FIG. 4).

It is assumed that the connection permission information sent to the portable communication terminal 1 by the information server apparatus 3 is updated periodically or every time the information processing apparatus 2 is connected to the communication network. The connection permission information maybe generated anew when it is sent to the portable communication terminal 1.

Upon receiving the connection permission information in the portable communication terminal 1 (step S12 in FIG. 4), the user makes connection to the information server apparatus 3 from the information processing apparatus 2 via the communication network 100 based upon the connection permission information and carries out jobs or the like (steps S21, S22, and S33 to S36 in FIG. 4).

In this case, time when the user starts connection to the information server apparatus 3 form the information processing apparatus 2 and time when the user ends the connection are recorded in the user information storage unit 34 of the information server apparatus 3 together with the location information of the portable communication terminal 1 (steps S34 and S36 in FIG. 4).

In this way, in this embodiment, access to the communication network 100 can be managed easily by using the portable communication terminal 1 provided with the location information detection unit 13 without depending upon a dedicated device such as a fingerprint reader or an ID card reader.

In addition, in this embodiment, even in the case in which start time and end time of access to the communication network 100 are managed to perform arrival and departure management (attendance management) of a user, since access is also confirmed according to location information of the portable information terminal 1, for example, it becomes possible to eliminate access from places other than those designated in advance (access other than that for business) and to perform appropriate management.

As described above, according to the present invention, there is an effect that control of connection or access to the network can be performed easily without using a dedicated device.

What is claimed is:

1. A network connection management system comprising:
a portable communication terminal including location information detecting means which detects location information of the terminal;
an access management server which, upon judging that connection to a network is to be permitted based upon a communication network connection request including at least ID information and location information from said portable communication terminal, sends to said portable communication terminal connection permission information for permitting connection to said network; and
an information processing apparatus for making connection to said network by sending the connection permission information obtained by said portable communication terminal.

2. The network connection management system according to claim 1,
wherein said access management server changes the connection permission information periodically.

3. The network connection management system according to claim 1,
wherein said access management server changes the connection permission information every time said information processing apparatus is connected to said network.

4. The network connection management system according to claim 1,
wherein said access management server includes means for recording start time and end time of connection to said network by said information processing apparatus and performs attendance management of a user of said information processing apparatus based upon the recorded start time and end time of connection.

5. The network connection management system according to claim 1,
wherein said access management server includes information storage means having a plurality of information areas and controls an access level to the information areas of said information storage means according to at least one of the location information from said portable communication terminal and time information.

6. A network connection management method comprising:
upon judging that connection to a network is to be permitted based upon a communication network connection request including at least ID information and location information from a portable communication terminal including location information detecting means which detects location information of the terminal, sending connection permission information, which permits connection to said network, to said portable communication terminal from an access management server for managing the connection permission information; and
making connection to said network by sending the connection permission information, which is obtained by said portable communication terminal, from an information processing apparatus.

7. The network connection management method according to claim 6,
wherein said access management server changes the connection permission information periodically.

8. The network connection management method according to claim 6,
wherein said access management server changes the connection permission information every time said information processing apparatus is connected to said network.

9. The network connection management method according to claim 6,
wherein said access management server records start time and end time of connection to said network by said information processing apparatus and performs attendance management of a user of said information processing apparatus based upon the recorded start time and end time of connection.

10. The network connection management method according to claim 6,
wherein said access management server controls an access level to information areas of information storage means of said access management server according to at least one of the location information from said portable communication terminal and time information.
